(19) United States
(12) Patent Application Publication
(10) Pub. No.: US 2023/0248005 A1
(43) Pub. Date: Aug. 10, 2023

(54) DOUGH STAMPING DEVICE, METHOD FOR GENERATING A DOUGH PRODUCT AND DOUGH PRODUCT

(71) Applicant: FRITSCH BAKERY TECHNOLOGIES GMBH & CO. KG, Markt Einersheim (DE)

(72) Inventor: Michael GIER, Kitzingen (DE)

(73) Assignee: FRITSCH BAKERY TECHNOLOGIES GMBH & CO. KG, Markt Einersheim (DE)

(21) Appl. No.: 18/107,462

(22) Filed: Feb. 8, 2023

(30) Foreign Application Priority Data
Feb. 9, 2022 (DE) 102022103033.4

(51) Int. Cl. A21C 11/10; A21C 3/06; A21C 9/08

(52) U.S. Cl. CPC A21C 11/10; A21C 3/06; A21C 9/085

(57) ABSTRACT

A dough stamping device for severing dough pieces from a dough sheet comprises a support, on which the dough sheet is depositable, and a blade assembly, which is configured to oscillate and perform indexed lifting actions in a substantially vertical direction. The blade assembly has a first group of blades, which is configured to at least partially generate an outer contour of a dough piece to be severed. In addition, the blade assembly has a second group of blades, which is configured to generate at least one slit inside of the outer contour of the dough piece.

### CROSS-REFERENCE TO RELATED APPLICATIONS

This application claims foreign priority benefits under 35 U.S.C. § 119(a)-(d) to German patent application number DE 10 2022 103 033.4, filed Feb. 9, 2022, which is incorporated by reference in its entirety.

### TECHNICAL FIELD

The disclosure relates to dough stamping devices, to methods for generating a dough product as well as to dough products.

### BACKGROUND

Though stamping devices are known for example from DE 197 20 689 A1. The device for the production of single dough pieces from a continuous dough sheet disclosed therein comprises a stamping tool, which is moved by a pneumatic cylinder to execute a stamping stroke. A dough processing device is known from EP 3 837 979 A1, which comprises an incision wheel having blades for inserting incisions into a dough sheet. This is supposed to generate incisions into a layer of a two-layer dough sheet, such that a two-color pattern is formed in the dough product to be generated from the dough sheet by differently colored dough layers. Since the incisions are inserted into the uncut dough sheet, their positions with respect to the subsequently generated dough pieces is undefined, such that the positioning of the pattern on the finished dough product is arbitrary.

### SUMMARY

It is an object of the disclosure to indicate an improved method for generating a dough product as well as a corresponding device, in particular a dough stamping device. This object is achieved by a dough stamping device according to the disclosure as well as by a method according to the disclosure.

It is a further object of the disclosure to provide a wound dough product, which enables a view on the filling contained therein. This object is achieved by a dough product according to the disclosure.

A dough stamping device for severing of dough pieces from a dough sheet is disclosed. The dough stamping device comprises a support, on which the dough sheet is depositable, and a blade assembly, which is configured to oscillate and perform indexed lifting actions in a substantially vertical direction. The blade assembly has a first group of blades, which is configured to at least partially generate an outer contour of a dough piece to be severed. The dough stamping device is characterized in that the blade assembly has a second group of blades, which is configured to generate at least one slit inside of the outer contour of the dough piece.

The blade assembly having a first group of blades for generating the outer contour as well as a second group of blades for generating at least one slit inside of the outer contour enables the slit to be positioned accurately with respect to the outer contour, such that the positioning of the slit on the dough product to be generated from the dough piece may be selectively influenced.

Within the scope of the description of the present disclosure, a group of blades may have a suitable number of blades. A single blade may be considered a group of blades as well. A preferred number of blades forming the second group of blades is three. Blades within the scope of the present disclosure may have different cutting edge geometries, for example a straight cutting edge, toothed cutting edge or corrugated edge.

It may be advantageous if the blade assembly is configured such that the first group and the second group engage the dough sheet during the same lifting action. This may enable acceleration of the generating of the dough pieces because the slit and the outer contour may be generated during the same lifting action. It may be particularly beneficial, if the blade assembly is configured such that the first group and the second group engage the dough sheet simultaneously. In this way, a further acceleration may be achieved.

It is conceivable, that the second group is configured to generate the at least one slit such that it extends through the dough sheet. This may ensure that the slit opens during baking of a product generated from the dough piece, such that an optionally present filling of the product may be exposed. A slit extending through the dough sheet may for example be generated by the second group of blades being configured to be brought into contact with the support and or be guided until they abut the support.

The present disclosure also relates to a dough processing facility having a dough stamping device of the previously described type and having a filling station, which is configured to apply a filling onto the dough piece. Advantageously, the dough processing facility may further comprise a winding station, which is configured to wind up the dough piece. As indicated further above, the dough stamping device may be particularly beneficial in the generation of filled, in particular wound and filled, dough products.

The present disclosure also relates to a method for generating a dough product. The method comprises providing a dough sheet on a support and severing of a dough piece from the dough sheet by a blade assembly of a dough stamping device. The blade assembly is configured to oscillate and perform indexed lifting actions in a substantially vertical direction. An outer contour of the dough piece is at least partially generated by a first group of blades of the blade assembly. The method is characterized by generating at least one slit inside of the outer contour of the dough piece by a second group of blades of the blade assembly.

It may be advantageous, if the severing of the dough piece and the generating of the slit occur during the same lifting action. This may accelerate the generating of the dough pieces because the slit and the outer contour may be generated during the same lifting action. It may be particularly beneficial, if the severing of the dough piece and the generating of the slit occur simultaneously. In this way further acceleration may be achieved.

It is conceivable that the at least one slit is generated such that it extends through the dough sheet. This may ensure that the slit widens during baking of a product generated from the dough piece, such that an optionally present filling of the product may be exposed. A slit extending through the dough sheet may be generated for example by the second group of blades being brought into contact with the support and or being guided until it abuts the support.

It is conceivable that the method further comprises applying of a filling onto the dough piece. It may be particularly beneficial, if the method further comprises a winding up of the dough piece. As indicated further above, the dough stamping device may be particularly advantageous in the generation of filled, in particular wound and filled, dough products.

The present disclosure further relates to a dough product having a dough piece spirally wound around a winding axis and a filling surrounded by the wound dough piece. The dough piece has at least one slit, which, in a wound state of the dough piece, extends spirally around the winding axis. The slit is configured to partially expose the filling at least after baking of the dough product. Such a dough product may enable the filling to be recognized touchless before a sale, which may be an advantage in particular with wound and filled products. A winding axis may be understood as an imaginary axis, which may in particular be disposed at an edge of the dough piece, on which the winding process is started.

### BRIEF DESCRIPTION OF THE DRAWINGS

The disclosure relates to a dough stamping device, a dough processing facility, a method for generating a dough product as well as a dough product of the previously described type. In the following, an embodiment of the disclosure is exemplarily described using drawings.

FIG. 1 shows a schematic side view of a dough processing facility;

FIG. 2A shows a schematic frontal view of a dough stamping device, wherein the perspective is indicated by line II-II in FIG. 1;

FIG. 2B shows the view from FIG. 2A, wherein a blade assembly is disposed in a cutting position;

FIG. 3 shows a schematic view from below of a blade assembly of the dough stamping device, wherein the perspective is indicated by line in FIG. 2A;

FIG. 4 shows a schematic top view from above of dough pieces in a severed and aligned position;

FIG. 5 shows a schematic perspective view of a dough product; and

FIG. 6 shows a schematic sectional view of the dough product from FIG. 5, wherein the cutting plane is indicated in FIG. 5 by the cutting line, VI-VI.

### DETAILED DESCRIPTION

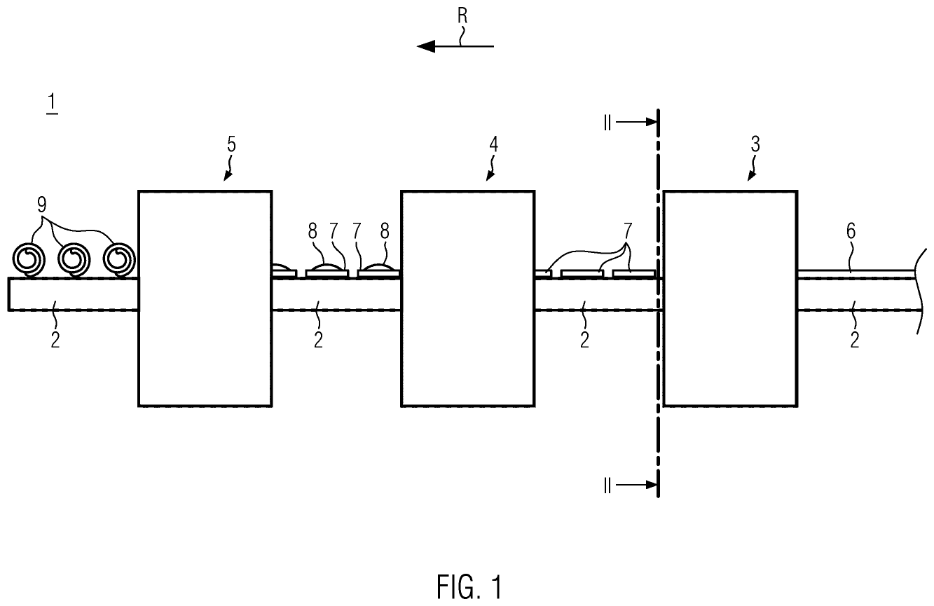

In FIG. 1, a dough processing facility 1 is illustrated in a schematic side view. The dough processing facility 1 may comprise different working stations, which are disposed sequentially along a production direction R. The dough processing facility 1 may further comprise one or more supports 2. Dough may be depositable in different states onto a support 2. As illustrated in the present embodiment, the support 2 or supports 2, respectively, may be embodied as a conveyor band or conveyor bands, respectively. The dough processing facility 1 may comprise a dough stamping device 3. In the illustrated portion of the dough processing facility 1 the dough stamping device 3 may embody the first working station. A skilled person, however, will recognize that various working stations may precede the dough stamping device 3 in the dough processing facility 1, for example a dough sheeter (not shown). The dough processing facility 1 may further comprise a filling station 4. The filling station 4 may be disposed after the dough stamping device 3 in the production direction R. The dough processing facility 1 may further comprise a winding station 5. The winding station 5 may be disposed after the dough stamping device 3 and the filling station 4 in the production direction R.

The support 2 may be configured to convey a dough sheet 6. The dough sheet 6 may be depositable on the support 2. The dough sheet 6 may initially be delivered to the dough stamping device 3 by the support 2. The dough stamping device 3 may be configured to sever dough pieces 7. The severed dough pieces 7 may be transported from the dough stamping device 3 to the filling station 4 by the support 2. The filling station 4 may be configured to apply a filling 8 onto the dough pieces 7. This may in particular be a pasty filling 8, for example a fruit or nut paste. Subsequently, the dough pieces having the filling 8 applied thereon may be transported from the filling station 4 to the winding station 5. The winding station 5 may be configured to wind up the dough piece 7. In particular, the winding station 5 may be configured to wind up the dough piece 7 in such a way that the filling 8 is enclosed in the dough piece 7. After the winding, wound dough products 9 may be present.

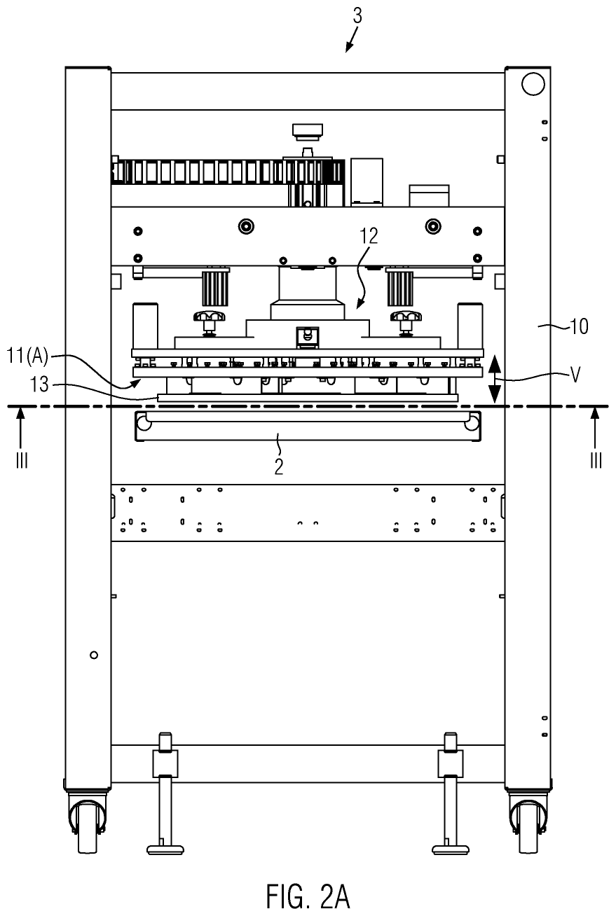

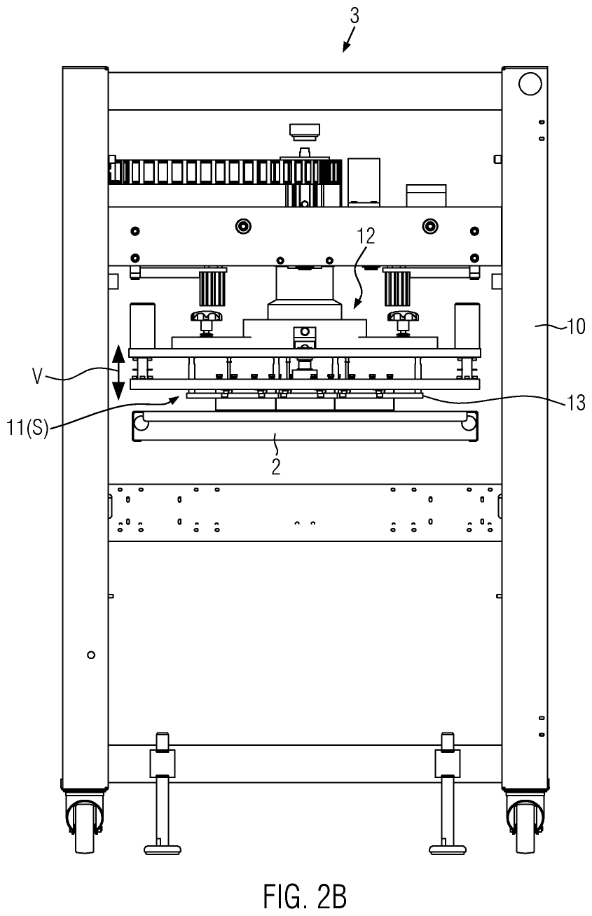

In FIG. 2, the dough stamping device 3 is illustrated in a schematic frontal view, wherein the direction of view is indicated in FIG. 1 by the line II-II. Now it can be seen that the dough stamping device 3 may comprise a frame 10. The frame 10 may be built portal like. The support 2 may extend through the frame 10. The dough stamping device 3 may comprise a blade assembly 11. The blade assembly 11 may be disposed at a tool carrier 12. The tool carrier 12 may be movably connected to the frame 10. The blade assembly 11 may be movable with respect to the frame 10 and or with respect to the tool carrier 12. In particular, the blade assembly 11 may be configured to oscillate in a substantially vertical direction V. The blade assembly 11 may comprise a stripper 13. FIG. 2A shows the blade assembly 11 in a position disposed at an upper dead center, which in the following may be referred to as starting position A. In FIG. 2B, the same view is illustrated as in FIG. 2A. However, the blade assembly 11 is shown in a cutting position S. In the cutting position S the blade assembly may be lowered with respect to the starting position A towards the support 2.

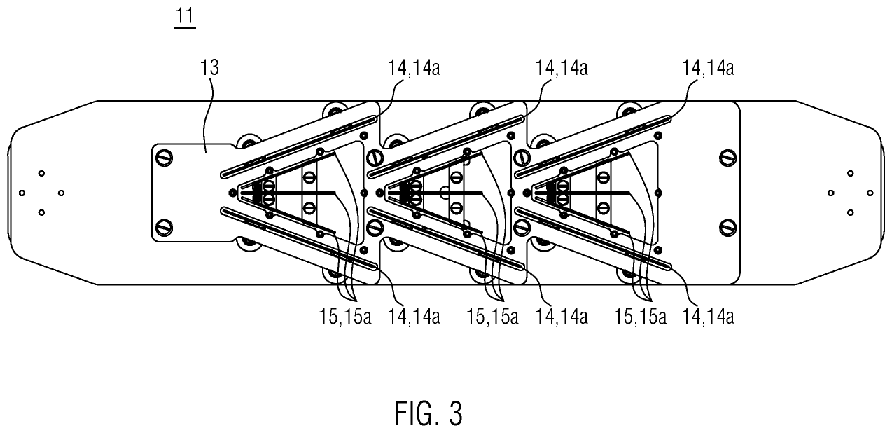

In FIG. 3, a schematic view from below of the blade assembly 11 is illustrated. The direction of view is indicated in FIG. 2A by the line III-III. The stripper 13 can be seen. It can be further seen that the blade assembly 11 may comprise a first group 14 of blades 14a. The blade assembly 11 may further comprise a second group 15 of blades 15a.

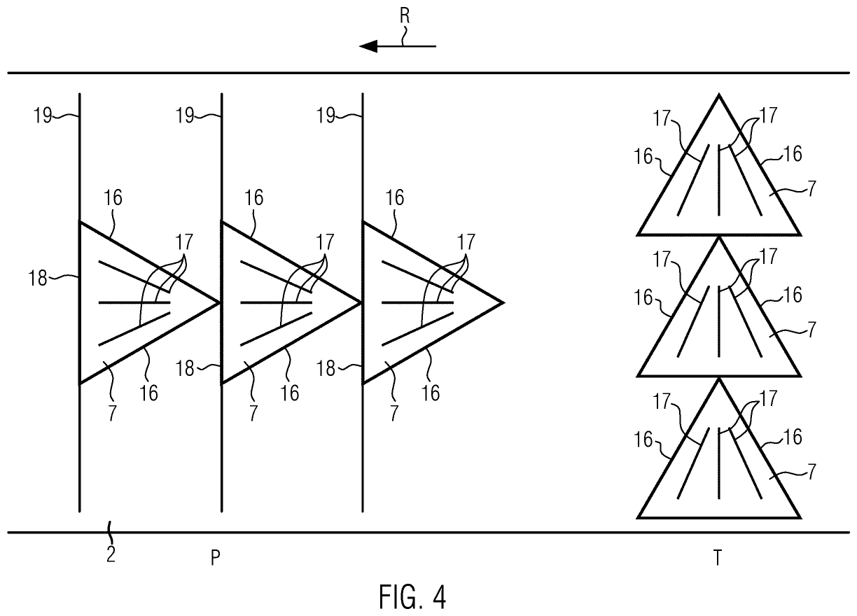

In FIG. 4, schematic top views of the dough pieces 7 are illustrated, which may be severable from the dough sheet 6 by the blade assembly 11. The dough pieces 7 may each have an outer contour 16. Further, at least one slit 17, in the present embodiment three slits 17, may be provided in each of the dough pieces 7. The slits 17 may be disposed inside of the outer contour 16, particularly completely inside the outer contour 16. The blade assembly 11 may be configured to sever the dough pieces 7 from the dough sheet 6. The first group 14 of blades 14a may be configured to generate the outer contour 16. The second group 15 of blades 15a may be configured to generate the slits 17.

In FIG. 4, the dough pieces 7 are shown in different positionings with respect to the production direction R. Immediately after the severing by the blade assembly 11, the dough pieces 7 may initially be disposed in a severing position T. After that, they may be shifted into an aligned position P. In particular, the dough stamping device 3 may be configured to shift the dough pieces 7 from the severing position T into the aligned position P. For this purpose, the tool carrier 12 may be movably disposed at the frame 10. For example, the tool carrier 12 may be configured according to the disclosure of DE 197 20 689 A1 and related U.S. Pat. No. 6,158,315, the contents of which are incorporated by reference into the present disclosure.

The aligned position P may facilitate a winding up of the dough pieces 7. In particular, a winding edge 18 may be aligned in front with respect to the production direction R. The winding edge 18 may be the edge of the dough piece 7, at which the winding process is started. An imaginary winding axis 19 may extend along the winding edge 18. A winding up of the dough pieces 7 may occur around the winding axis 19. After shifting into the aligned position P, the dough pieces 7 may be transported to the filling station 4, in particular by the support 2, in the present embodiment the conveyor band. The filling station 4 may be configured to apply the filling 8 onto the dough pieces 7. For example, the filling station 4 may comprise a filling station conveyor (e.g., conveyor belt or band), which may be part of the support 2, for transporting the dough pieces 7 (e.g., in the production direction R) and/or one or more filling nozzles for applying a filling onto the dough pieces 7 disposed on the conveyor. After a further transport by the support 2, in the present embodiment the conveyor band, to the winding station 5, dough products 9 may be generated by the winding station 5 by winding the dough pieces 7 around the winding axis 19 starting at the winding edge 18. For example, the winding station 5 may comprise a winding station conveyor (e.g., conveyor belt or band), which may be part of the support 2, for transporting the dough pieces 7 (e.g., in the production direction R) and/or a winding mat and/or a winding board and/or a winding band and/or a winding belt and/or one or more hooks, wherein the winding mat and/or the winding board and/or the winding belt and/or the one or more hooks may each be engageable with the dough pieces 7 to facilitate winding of the dough pieces.

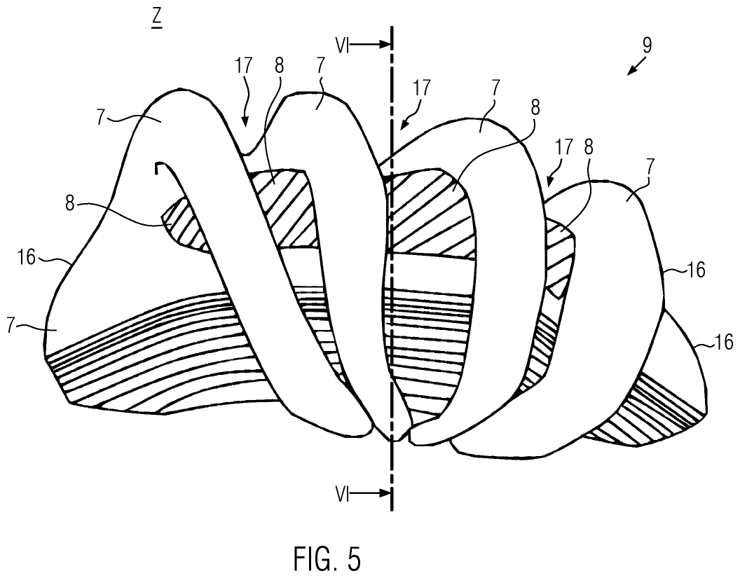

In FIG. 5, a wound up dough product 9 is shown in a schematic perspective view. FIG. 5 shows a wound up state Z of the dough piece 7. The dough product 9 is shown in a baked state. The baked state may be characterized in that the slits 17 have widened and exposed the filling 8.

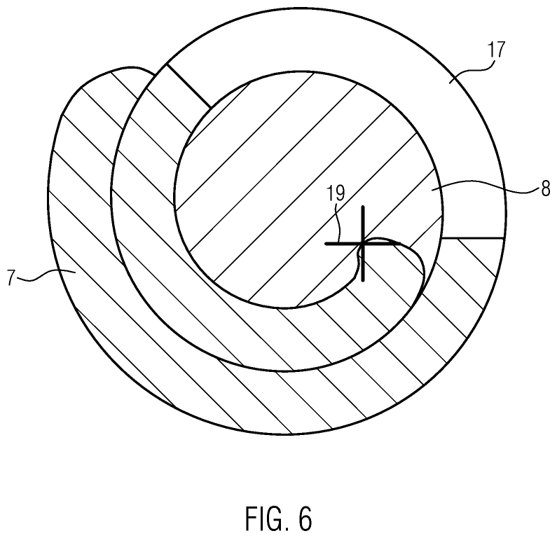

In FIG. 6, a schematic sectional view of the dough product 9 is shown, wherein the cutting plane is indicated in FIG. 5 by the line VI-VI. The cutting plane extends through one of the slits 17. From FIG. 6 it can be seen, that the dough piece 7 may spirally extend around the winding axis 19 in the wound state. It can also be seen that the slit 17 may spirally extend around the winding axis 19.

What is claimed is:

1. A dough stamping device for severing dough pieces from a dough sheet, comprising:
a support, on which the dough sheet is depositable; and
a blade assembly, which is configured to oscillate and perform indexed lifting actions in a substantially vertical direction, wherein the blade assembly has a first group of blades, which is configured to at least partially generate an outer contour of a dough piece to be severed, and the blade assembly has a second group of blades, which is configured to generate at least one slit inside of the outer contour of the dough piece.

2. The dough stamping assembly according to claim 1, wherein the blade assembly is configured such that the first group and the second group engage the dough sheet during the same lifting action.

3. The dough stamping assembly according to claim 1, wherein the blade assembly is configured such that the first group and the second group engage the dough sheet simultaneously.

4. The dough stamping assembly according to claim 1, wherein the second group is configured to generate the at least one slit such that it extends through the dough sheet.

5. A dough processing facility having the dough stamping device according to claim 1, and a filling station, which is configured to apply a filling onto the dough piece.

6. The dough processing facility according to claim 5, further comprising a winding station, which is configured to wind up the dough piece.

7. A method for generating a dough product (9), comprising:
providing a dough sheet on a support;
severing of a dough piece from the dough sheet by a blade assembly of a dough stamping device, wherein the blade assembly is configured to oscillate and perform indexed lifting actions in a substantially vertical direction, and wherein an outer contour of the dough piece is at least partially generated by a first group of blades of the blade assembly; and
generating at least one slit inside of the outer contour of the dough piece by a second group of blades of the blade assembly.

8. The method according to claim 7, wherein the severing of the dough piece and the generating of the slit occur during a same lifting action.

9. The method according to claim 7, wherein the severing of the dough piece and the generating of the slit occur simultaneously.

10. The method according to claim 7, wherein the at least one slit is generated such that it extends through the dough sheet.

11. The method according to claim 7, further comprising applying a filling onto the dough piece.

12. The method according to claim 7, further comprising winding up the dough piece.

13. A dough product having a dough piece spirally wound around a winding axis and a filling surrounded by the wound dough piece, wherein the dough piece has at least one slit, which, in a wound state of the dough piece, extends spirally around the winding axis, and wherein the slit is configured to partially expose the filling at least after baking of the dough product.
